(19) United States
(12) Patent Application Publication
(10) Pub. No.: US 2009/0327380 A1
(43) Pub. Date: Dec. 31, 2009

(54) Circuit and method of generating a random number using a phass-locked-loop circuit

(75) Inventor: Young-Kyun Cho, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/731,927

(22) Filed: Apr. 2, 2007

(30) Foreign Application Priority Data
Apr. 4, 2006 (KR) 10-2006-0030678

(51) Int. Cl. G06F 7/58

(52) U.S. Cl. 708/251

(57) ABSTRACT

A circuit that generates a random number includes a phase-locked loop circuit and a sampling circuit. The phase-locked loop circuit generates an internal clock signal that is synchronized with a reference signal in which the internal clock has a random noise. The sampling circuit samples the reference signal in response to the internal clock signal to generate a random data bit. The circuit of generating a random number is capable of generating a random number with high randomness and is capable of operating at a relatively low frequency.

### CROSS-REFERENCE TO RELATED APPLICATIONS

This application claims priority under 35 USC § 119 to Korean Patent Application No. 10-2006-0030678, filed on Apr. 4, 2006 in the Korean Intellectual Property Office (KIPO), the disclosure of which is incorporated herein by reference in its entirety.

### BACKGROUND OF THE INVENTION

1. Field of the Invention

Example embodiments of the present invention relate to a circuit and a method of generating a random number, and more particularly to a circuit and a method of generating a random number using a phase-locked loop circuit.

2. Description of the Related Art

As the exchange of information continues to become increasingly important in modern society, electronic devices continue to become more complicated and more sophisticated. Enhanced encryption technologies are utilized for preventing data reproduction and protection of private information. Encryption systems require a random number generating circuit and particularly, require a sophisticated random number generating circuit for increasing security.

Various methods have been attempted for random number generation. According to some methods, a random number can be generated in response to the randomness of nature, such as thermal noise, radioactivity disintegration, etc. According to other methods, a random number can be generated by using a meta stability of flip-flop and/or an oscillation signal that has a jitter.

A random number generating device is required to have a statistical balance such that the random number generating device is not biased toward a “0” state or a “1” state when sampled.

FIG. 1 is a circuit diagram illustrating a conventional random number generating circuit.

A random number generating circuit 10 in FIG. 1 includes a noise source 12 that is implemented with resistance, an amplifier 14, and a comparator 16. The amplifier 14 amplifies a noise signal generated by the noise source 12. The comparator 16 outputs the noise signal amplified by the amplifier 14 in response to a clock signal CLK. An output data bit BOUT of the comparator 16 has a randomized bit value.

FIG. 2 is a circuit diagram illustrating another conventional random number generating circuit.

A random number generating circuit 20 in FIG. 2 includes a high-speed oscillator 22, and a D flip-flop 24. The fast oscillator 22 generates an oscillation signal FOSC having a relatively high frequency. The D flip-flop 24 samples the high-frequency oscillation signal FOSC in response to a clock signal SCLK having a relatively low frequency and outputs an output data bit BOUT.

FIG. 3 is a circuit diagram illustrating still another conventional random number generating circuit.

A random number generating circuit 30 in FIG. 3 includes cascade-coupled D flip-flops 31, 32, 33 and 34, and EXOR gates 36 and 37. The D flip-flops 31, 32, 33 and 34 have random states, respectively. The EXOR gates 36 and 37 perform a function of a parity generator and perform a bias compensation. A high-frequency clock signal HFCLK is input to an input terminal of the D flip-flop 31, and a low-frequency clock signal JCLK having a jitter is input to clock terminals CK of the D flip-flops 31, 32, 33 and 34.

As described above, a random number can be generated by the circuits having the various configurations above. The circuits and methods of generating random numbers illustrated in FIG. 2 and FIG. 3, however, are limited by their lowering of a frequency of the clock signal that has jitter.

### SUMMARY OF THE INVENTION

Accordingly, embodiments of the present invention substantially obviate one or more problems associated with limitations and disadvantages of the related art.

Some embodiments of the present invention provide a circuit of generating a random number with high randomness capable of being operated at a relatively low frequency.

Some embodiments of the present invention provide a method of generating a random number with high randomness capable of being performed at a relatively low frequency.

In one aspect, a circuit of generating a random number includes a phase-locked loop circuit and a sampling circuit. The phase-locked loop circuit generates an internal clock signal that is synchronized with a reference signal in which the internal clock signal has a random noise. The sampling circuit samples the reference signal in response to the internal clock signal to generate a random data bit.

The sampling circuit can include a D flip-flop. The internal clock signal can have a normal distribution.

The phase-locked loop circuit can include a phase-frequency detector, a charge pump, a low-pass filter, a random noise voltage-controlled oscillator and a feedback loop. The phase-frequency detector generates an up signal and a down signal by detecting a phase difference between the feedback signal and the reference signal. The charge pump generates a current signal in response to the up signal and the down signal. The low-pass filter passes a low frequency of the current signal to generate a control voltage. The random noise voltage-controlled oscillator generates the random noise and generates the internal clock signal having a variable frequency in response to the random noise and the control voltage. The feedback loop generates the feedback signal based on the internal clock signal.

The random noise voltage-controlled oscillator may include a noise generator and a voltage-controlled oscillator. The noise generator generates the random noise having a plurality of states. The voltage-controlled oscillator generates the internal clock signal in response to the random noise and the control voltage.

The random noise voltage-controlled oscillator can further include a guard ring that prevents the random noise from influencing external circuits.

The random noise can be generated from a substrate of a wafer.

The noise generator can include a first through an Nth D flip-flops and an EXOR gate. The first through the Nth D flip-flops are cascade-coupled with one another and operate in response to the reference signal. The EXOR gate outputs a first voltage signal based on an output of the (N−1)th D flip-flop and an output of the Nth D flip-flop, and provides the first voltage signal to an input terminal of the first D flip-flop.

The feedback loop may include a first divider that divides the output signal of the random noise voltage-controlled oscillator by a division ratio M where M is a natural number.

The phase-locked loop circuit may further include a second divider that divides the output signal of the random noise voltage-controlled oscillator by a division ratio of N to generate the internal clock signal where N is a natural number.

In another aspect, a method of generating a random number includes generating an internal clock signal synchronized with a reference signal in which the internal clock signal has a random noise, and sampling the reference signal in response to the internal clock signal to generate a random data bit.

Generating the internal clock signal can include generating an up signal and a down signal by detecting a phase gap between the feedback signal and the reference signal, generating a current signal in response to the up signal and the down signal, passing a low frequency of the current signal to generate a control voltage, generating the random noise, generating the internal clock signal having a variable frequency in response to the random noise and the control voltage, and generating the feedback signal based on the internal clock signal.

Generating the internal clock signal can include generating the random noise having a plurality of states, and generating the internal clock signal in response to the random noise and the control voltage.

Therefore, the circuit of generating a random number according to example embodiments of the present invention can generate a random number with high randomness and can operate at a relatively low frequency.

### BRIEF DESCRIPTION OF THE DRAWINGS

The foregoing and other objects, features and advantages of the embodiments of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a circuit diagram illustrating a conventional random number generating circuit.

FIG. 2 is a circuit diagram illustrating another conventional random number generating circuit.

FIG. 3 is a circuit diagram illustrating still another conventional random number generating circuit.

FIG. 4 is a circuit diagram illustrating a random number generating circuit according to an example embodiment of the present invention.

FIG. 5 is a timing diagram illustrating an operation of the random number generating circuit in FIG. 4.

FIG. 6 is a block diagram illustrating an example of a phase-locked loop circuit included in the random number generating circuit in FIG. 4.

FIG. 7 is a diagram illustrating an example of a random noise voltage-controlled oscillator included in the phase-locked loop circuit in FIG. 6.

FIG. 8 is a circuit diagram illustrating an example of a noise generator included in the random noise voltage-controlled oscillator in FIG. 7.

FIG. 9 is a circuit diagram illustrating an example of a voltage-controlled oscillator included in the random noise voltage-controlled oscillator in FIG. 7.

FIG. 10 is a block diagram illustrating another example of a phase-locked loop circuit included in the random number generating circuit in FIG. 4.

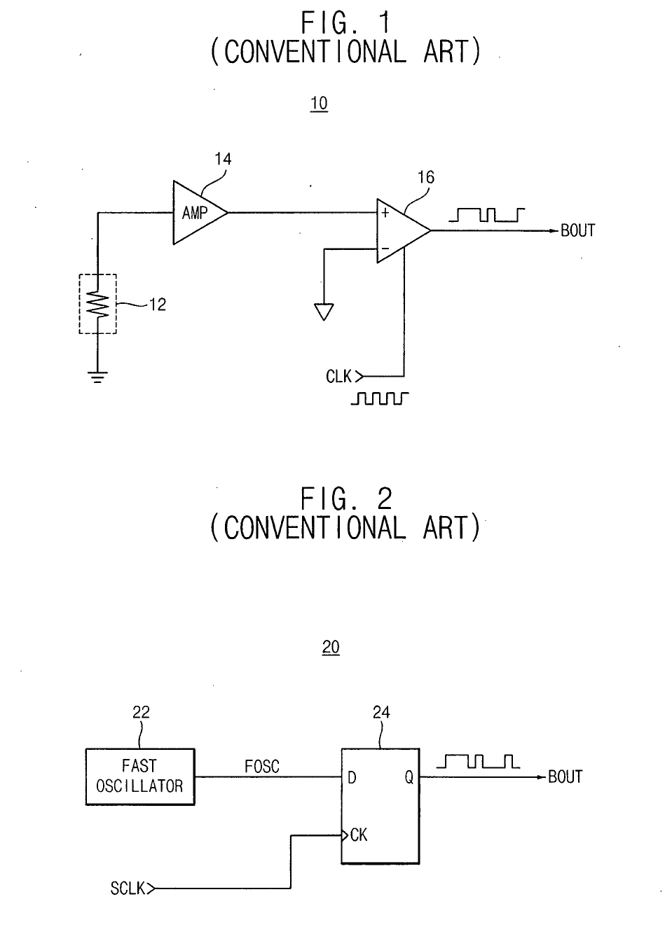

### DESCRIPTION OF THE EMBODIMENTS

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

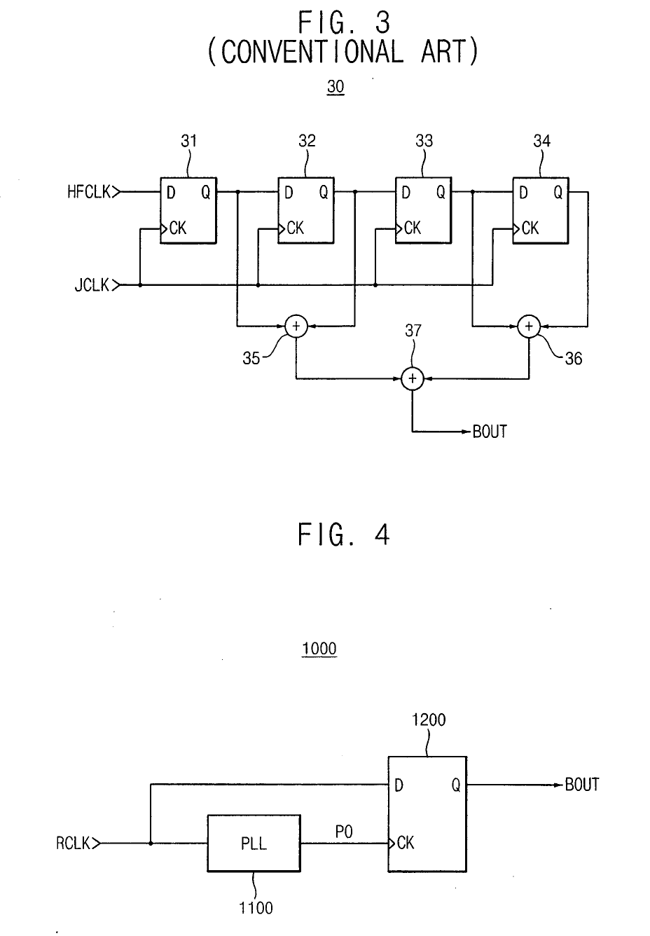

FIG. 4 is a circuit diagram illustrating a random number generating circuit according to an example embodiment of the present invention.

Referring to FIG. 4, the random number generating circuit 1000 includes a phase-locked loop circuit 1100, and a D flip-flop 1200.

The phase-locked loop circuit 1100 generates an internal clock signal PO that is synchronized with a reference signal RCLK and has a random noise. The D flip-flop 1200 samples the reference signal RCLK to generate a random data bit BOUT in response to the internal clock signal PO.

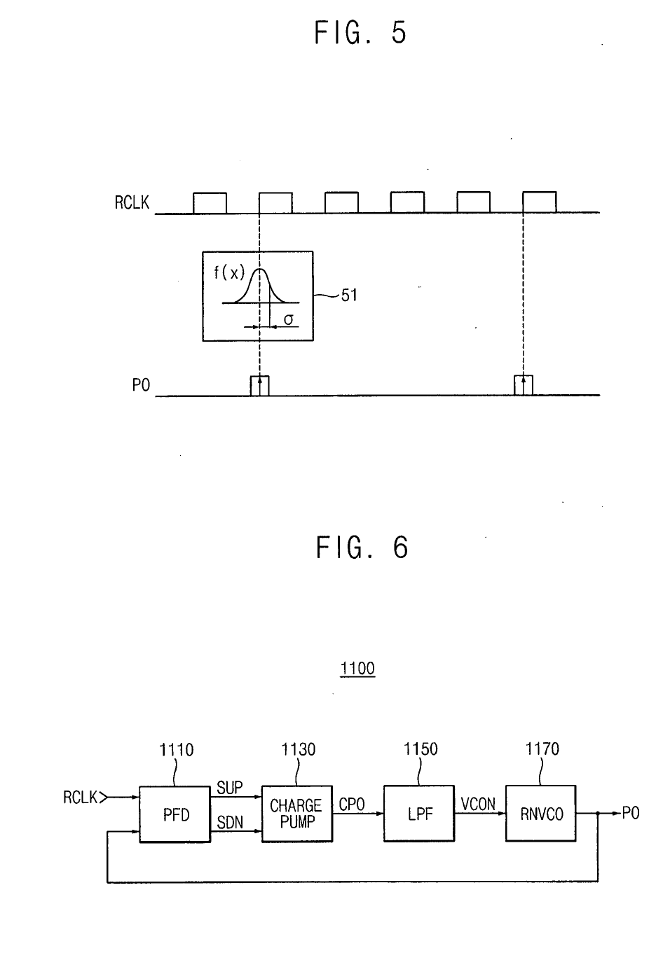

FIG. 5 is a timing diagram illustrating an operation of the random number generating circuit in FIG. 4.

Hereinafter, the operation of the random number generating circuit will be described with reference to FIGS. 4 and 5.

Referring to FIG. 5, the output signal PO of the phase-locked loop circuit 1100, that is, the internal clock signal, is synchronized with the reference signal RCLK and includes jitter noise. In addition, the output signal PO of the phase-locked loop circuit 1100 has a normal distribution profile as illustrated in block 51. In the random number generating circuit 1000 in FIG. 4, the clock signal PO synchronized by the phase-locked loop circuit 1100 is input to a clock terminal CK of D flip-flop 1200 that samples the internal clock signal PO. Thus, the resulting output random data bit BOUT has high randomness and the high randomness of the random data bit BOUT may be maintained although the synchronized clock signal PO with a relatively low randomness is sampled. The phase-locked loop circuit 1100 has a random noise voltage-controlled oscillator 1170 and generates the jitter noise as will be described.

FIG. 6 is a block diagram illustrating an example of a phase-locked loop circuit included in the random number generating circuit of FIG. 4.

Referring to FIG. 6, the phase-locked loop circuit 1100 includes a phase-frequency detector 1110, a charge pump 1130, a low-pass filter 1150, a random noise voltage-controlled oscillator 1170 and a feedback loop.

The phase-frequency detector 1110 compares a phase and/or a frequency of a feedback signal with a phase and/or a frequency of the reference signal RCLK. The phase-frequency detector 1110 detects a phase difference between the feedback signal and the reference signal RCLK and generates an up signal SUP and a down signal SDN. The charge pump 1130 generates a current signal CPO in response to the up signal SUP and the down signal SDN. The low-pass filter 1150 passes a low frequency of the current signal CPO and generates a control voltage VCON. The random noise voltage-controlled oscillator 1170 generates the random noise and the internal clock signal PO having a variable frequency in response to the random noise and the control voltage VCON. The feedback loop feeds back the internal clock signal PO to an input terminal of the phase-frequency detector 1110.

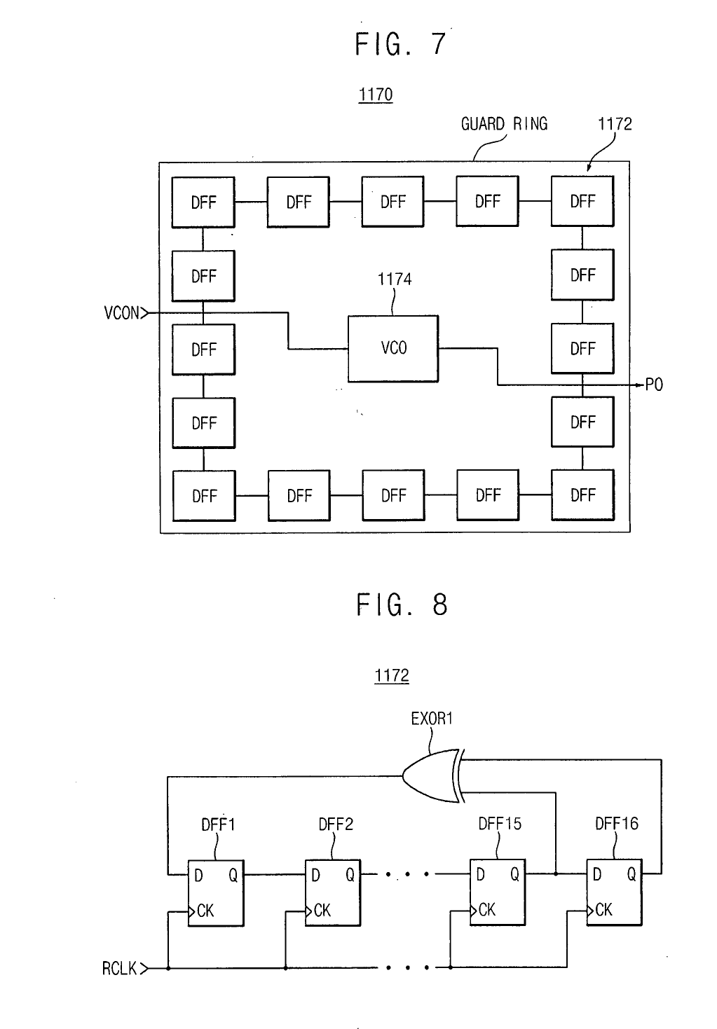

FIG. 7 is a diagram illustrating an example of a random noise voltage-controlled oscillator included in the phase-locked loop circuit in FIG. 6.

Referring to FIG. 7, the random noise voltage-controlled oscillator 1170 includes a noise generator 1172 and a voltage-controlled oscillator 1174.

The noise generator 1172 may be implemented with a chain of D flip-flops, and generates a random noise having a plurality of states. The random noise that is generated by the noise generator 1172 including a number N of D flip-flops (N is a natural number) is generated from a substrate of a wafer, and the random noise may have 2^{N} states. The voltage-controlled oscillator 1174 generates an internal clock signal PO in response to the random noise and a control voltage VCON. The random noise voltage-controlled oscillator 1170 in FIG. 7 includes a guard ring for preventing the random noise from influencing external circuits. The internal clock signal PO, i.e., an output signal of the random noise voltage-controlled oscillator 1170 includes the random noise and has a normal distribution as illustrated in FIG. 5.

FIG. 8 is a circuit diagram illustrating an example of a noise generator included in the random noise voltage-controlled oscillator in FIG. 7.

FIG. 8 illustrates an example of the noise generator 1172 that includes sixteen D flip-flops DFF1 through DFF16 and an EXOR gate EXOR1. The configuration as illustrated in FIG. 8 is referred to as a pseudo-random binary sequence PRBS.

Referring to FIG. 8, the D flip-flops DFF1 through DFF16 of the noise generator 1172 operate in response to a reference signal RCLK and D flip-flops DFF1 through DFF16 are cascade-coupled to one another. The EXOR gate EXOR1 outputs a first voltage signal based on an output of the 15th D flip-flop DFF15 and an output of the 16th D flip-flop DFF16, and then outputs the first voltage signal to an input terminal of the first D flip-flop DFF1.

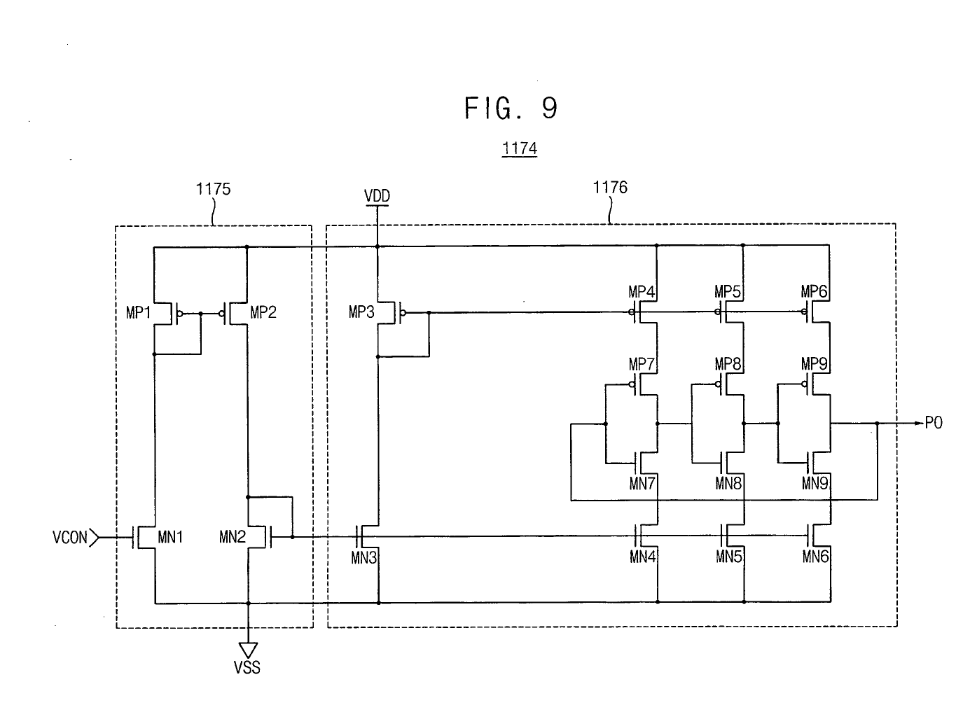

FIG. 9 is a circuit diagram illustrating an example of a voltage-controlled oscillator included in the random noise voltage-controlled oscillator in FIG. 7.

Referring to FIG. 9, the voltage-controlled oscillator 1174 includes a bias circuit 1175 and an oscillating circuit 1176.

The bias circuit 1175 generates a variable bias voltage in response to a control voltage VCON. The oscillating circuit 1176 generates a variable internal clock signal PO in response to the bias voltage.

The bias circuit 1175 includes PMOS transistors MP1 and MP2, and NMOS transistors MN1 and MN2. The PMOS transistor MP1 has a source coupled to a higher power supply voltage VDD. In addition, the PMOS transistor MP1 has a gate and a drain that are coupled to each other. The PMOS transistor MP2 has a source coupled to the high power supply voltage VDD. In addition, the PMOS transistor MP2 has a gate coupled to the gate of the PMOS transistor MP1. The NMOS transistor MN1 has a gate receiving the oscillating control voltage VCON. In addition, the NMOS transistor MN1 has a drain coupled to the drain of the PMOS transistor MP1 and a source coupled to a low power supply voltage VSS. The NMOS transistor MN2 has a drain and a gate that are commonly coupled to the drain of the PMOS transistor MP2. In addition, the NMOS transistor MN2 has a source coupled to the lower power supply voltage VSS.

The oscillating circuit 1176 includes PMOS transistors MP3 through MP9 and NMOS transistors MN3 through MN9. The NMOS transistors MN3 through MN9 are coupled to the NMOS transistor MN2 in a current mirror configuration. The PMOS transistors MP4 through MP6 are coupled to the PMOS transistor MP3 in a current mirror configuration.

The PMOS transistors MP7 through MP9 and the NMOS transistors MN7 through MN9 may form a ring oscillator. The PMOS transistor MP7 and the NMOS transistor MN7 constitute an inverter, and the PMOS transistor MP8 and the NMOS transistor MN8 constitute another inverter. The PMOS transistor MP9 and the NMOS transistor MN9 constitute still another inverter. An input terminal of the inverter including the PMOS transistor MP7 and the NMOS transistor MN7 and an input terminal of the inverter including the PMOS transistor MP9 and the NMOS transistor MN9 are electrically coupled to each other. Thus, an output voltage PO of the oscillating circuit 1176 is caused to oscillate.

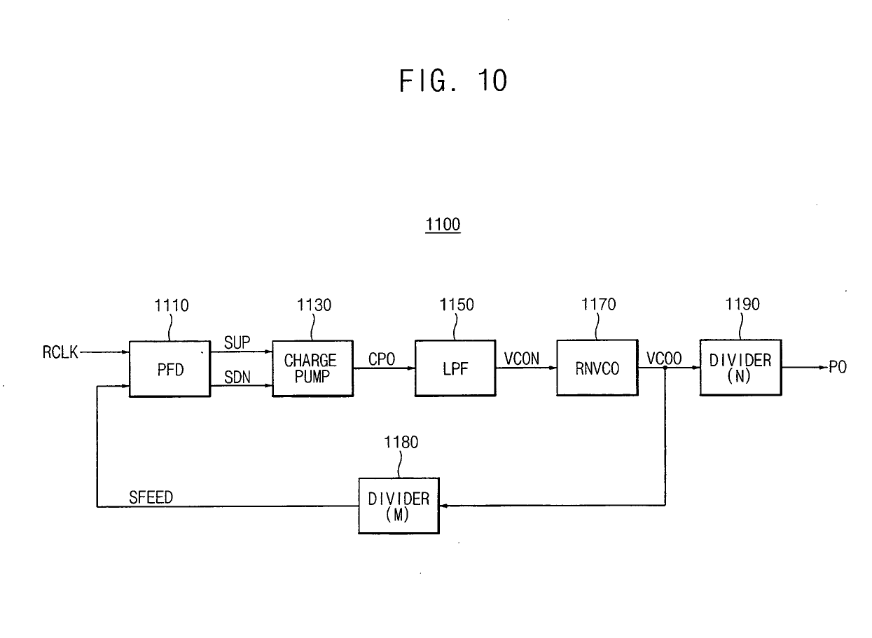

FIG. 10 is a block diagram illustrating another example of a phase-locked loop circuit included in the random number generating circuit in FIG. 4.

Referring to FIG. 10, the phase-locked loop circuit 1100 includes a phase-frequency detector 1110, a charge pump 1130, a low-pass filter 1150, a random noise voltage-controlled oscillator 1170, a first divider 1180 and a second divider 1190.

The phase-frequency detector 1110 compares a phase and/or a frequency of a feedback signal with a phase and/or a frequency of a reference signal RCLK. The phase-frequency detector 1110 detects a phase difference between the feedback signal and the reference signal RCLK and generates an up signal SUP and a down signal SDN. The charge pump 1130 generates a current signal CPO in response to the up signal SUP and the down signal SDN. The low-pass filter 1150 passes a low frequency of the current signal CPO and generates a control voltage VCON. The random noise voltage-controlled oscillator 1170 generates the random noise and the internal clock signal PO having a variable frequency in response to the random noise and the control voltage VCON. The first divider 1180 divides an output signal VCOO of the random noise voltage-controlled oscillator 1170 by a division ratio of M, and feeds back the divided signal divided to the phase-frequency detector 1110. The second divider 1190 divides an output signal VCOO of the random noise voltage-controlled oscillator 1170 by a division ratio of N, and generates an internal clock signal PO.

The first divider 1180 performs a function to increase a frequency of the output signal VCOO of the random noise voltage-controlled oscillator 1170. The second divider 1190 performs a function to decrease the frequency of the output signal VCOO of the random noise voltage-controlled oscillator 1170.

As mentioned above, the random number generating circuit according to is example embodiments of the present invention can generate a random number with high randomness and can operate at a relatively low frequency.

While the example embodiments of the present invention and their advantages have been described in detail, it should be understood that various changes, substitutions and alterations may be made herein without departing from the scope of the invention.

What is claimed is:

1. A circuit of generating a random number comprising:
a phase-locked loop circuit configured to generate an internal clock signal synchronized with a reference signal, the internal clock signal having a random noise; and
a sampling circuit configured to sample the reference signal in response to the internal clock signal to generate a random data bit.

2. The circuit of claim 1, wherein the sampling circuit comprises a D flip-flop.

3. The circuit of claim 1, wherein the internal clock signal has a normal distribution.

4. The circuit of claim 1, wherein the phase-locked loop circuit comprises:
a phase-frequency detector configured to generate an up signal and a down signal by detecting a phase difference between the feedback signal and the reference signal;
a charge pump configured to generate a current signal in response to the up signal and the down signal;
a low-pass filter configured to pass a low frequency of the current signal to generate a control voltage;
a random noise voltage-controlled oscillator configured to generate the random noise, and configured to generate the internal clock signal having a variable frequency in response to the random noise and the control voltage; and
a feedback loop configured to generate the feedback signal based on the internal clock signal.

5. The circuit of claim 4, wherein the random noise voltage-controlled oscillator comprises:
a noise generator configured to generate the random noise having a plurality of states; and
a voltage-controlled oscillator configured to generate the internal clock signal in response to the random noise and the control voltage.

6. The circuit of claim 5, wherein the random noise voltage-controlled oscillator further comprises a guard ring that prevents the random noise from influencing external circuits.

7. The circuit of claim 6, wherein the random noise is generated from a substrate of a wafer.

8. The circuit of claim 7, wherein the noise generator comprises:
a first through an Nth D flip-flops cascade-coupled with one another and configured to operate in response to the reference signal; and
an EXOR gate configured to output a first voltage signal based on an output of the (N−1)th D flip-flop and an output of the Nth D flip-flop, and configured to provide the first voltage signal to an input terminal of the first D flip-flop.

9. The circuit of claim 4, wherein the feedback loop includes a first divider that divides the output signal of the random noise voltage-controlled oscillator by a division ratio of M, M being a natural number.

10. The circuit of claim 9, wherein the phase-locked loop circuit further includes a second divider that divides the output signal of the random noise voltage-controlled oscillator by a division ratio of N to generate the internal clock signal, N being a natural number.

11. A method of generating a random number comprising:
generating an internal clock signal synchronized with a reference signal, the internal clock signal having a random noise component; and
sampling the reference signal in response to the internal clock signal to generate a random data bit.

12. The method of claim 11, wherein generating the internal clock signal comprises:
generating an up signal and a down signal by detecting a phase difference between a feedback signal and the reference signal;
generating a current signal in response to the up signal and the down signal;
passing a low frequency of the current signal to generate a control voltage;
generating the random noise;
generating the internal clock signal having a variable frequency in response to the random noise and the control voltage; and
generating the feedback signal based on the internal clock signal.

13. The method of claim 12, wherein generating the internal clock signal comprises:
generating the random noise having a plurality of states; and
generating the internal clock signal in response to the random noise and the control voltage.
